(19) United States
(12) Patent Application Publication
(10) Pub. No.: US 2025/0035273 A1
(43) Pub. Date: Jan. 30, 2025

(54) WATERPROOF LIGHT STRING

(71) Applicant: SHENZHEN ENNOPLUS TECHNOLOGY CO., LTD., SHENZHEN (CN)

(72) Inventor: WEIBO ZHANG, SHENZHEN (CN)

(21) Appl. No.: 18/432,522

(22) Filed: Feb. 5, 2024

(30) Foreign Application Priority Data
Jul. 24, 2023 (CN) 202321965475.5

(51) Int. Cl. F21S 4/10; F21V 17/06; F21V 21/08; F21V 31/00; F21Y 101/00

(52) U.S. Cl. CPC F21S 4/10; F21V 17/06; F21V 21/08; F21V 31/005; F21Y 2101/00

(57) ABSTRACT

A waterproof light string includes a wire assembly, lamp beads, and waterproof assemblies. The wire assembly includes wire groups and insulating layers respectively covering the wire groups. Each of the lamp beads is electrically connected to corresponding two adjacent wire groups. Each of the waterproof assemblies includes a first shell, a second shell, and a waterproof cover. Each first shell includes a first waterproof portion and a light-transmitting portion fixedly connected to the first waterproof portion. Each light-transmitting portion is capable of transmitting light. Each second shell includes a second waterproof portion and a positioning portion fixedly connected to the second waterproof portion. Each first waterproof portion is fixedly connected to a corresponding second waterproof portion to limit a corresponding lamp bead between each first waterproof portion and the corresponding second waterproof portion. Each waterproof cover prevent liquid from entering each of the lamp beads.

### TECHNICAL FIELD

The present disclosure relates to a field of lamps, and in particular to a waterproof light string.

### BACKGROUND

Light strings, such as light-emitting diode (LED) light strings, are a kind of decorative lighting including luminous lamp beads, wires, etc., and are widely used in decoration, architecture, landscape and other industries. LED light strings are favored by people because of energy saving, environmental protection, beautiful appearance, and low price.

A conventional light string production process generally arranges lamp beads on wires at intervals to form a conventional light string in which the lamp beads are connected in series. The wires of the conventional light string are generally covered with a soft insulation layer, and the lamp beads generally include lamp bead substrates and light-emitting chips. Each of the light-emitting chips is disposed on a corresponding lamp bead substrate. The lamp bead substrates and the wires are welded to electrically connect the light-emitting chips and the wires.

In order to increase aesthetics of the conventional light string, hanging pieces are generally disposed on positions of the lamp beads of the conventional light string. Each of the hanging pieces generally includes a lamp shell disposed outside a corresponding light-emitting chip. Each lamp shell is capable of transmitting light. Each lamp shell and a corresponding lamp bead substrate are generally connected and fixed through a fixing structure. However, a fixed connection position between each lamp shell and the corresponding lamp bead substrate is generally not waterproof, resulting in limited use scenarios of the conventional light string. For instance, the conventional light string is unable to be used outdoors for a long time.

### SUMMARY

Embodiments of the present disclosure provide a waterproof light string in which lamp beads thereof is effectively waterproof, so that the waterproof light string is capable of being used outdoors for a long time.

In a first aspect, in one embodiment, the present disclosure provides a waterproof light string. The waterproof light string includes a wire assembly, lamp beads, and waterproof assemblies.

The wire assembly includes wire groups and insulating layers. Each of the insulating layers covers an outer side of a corresponding wire group of the wire groups.

Each of the lamp beads is electrically connected to corresponding two adjacent wire groups. Each of the waterproof assemblies includes a first shell, a second shell, and a waterproof cover.

Each first shell includes a first waterproof portion and a light-transmitting portion fixedly connected to the first waterproof portion. Each light-transmitting portion is capable of transmitting light generated by a corresponding lamp bead of the lamp beads. Each second shell includes a second waterproof portion and a positioning portion fixedly connected to the second waterproof portion. Each first waterproof portion is fixedly connected to a corresponding second waterproof portion to limit a corresponding lamp bead between each first waterproof portion and the corresponding second waterproof portion. Each waterproof cover covers a corresponding first waterproof portion and a corresponding second waterproof portion, and each waterproof cover is fixedly connected to the corresponding first waterproof portion and the corresponding second waterproof portion, so as to prevent liquid from entering each of the lamp beads from a gap between each first waterproof portion and the corresponding second waterproof portion.

In a second aspect, in another embodiment, the present disclosure provides a waterproof light string. The waterproof light string includes wire groups, lamp beads, and waterproof assemblies.

Each of the lamp beads is electrically connected to corresponding two adjacent wire groups. The lamp beads are accommodated in the waterproof assemblies.

Each of the waterproof assemblies includes a first shell, a second shell, and a waterproof cover.

Each first shell includes a first waterproof portion and a light-transmitting portion fixedly connected to the first waterproof portion. Each light-transmitting portion is capable of transmitting light generated by a corresponding lamp bead of the lamp beads. Each second shell includes a second waterproof portion and a positioning portion fixedly connected to the second waterproof portion. Each first waterproof portion is fixedly connected to a corresponding second waterproof portion to limit a corresponding lamp bead between each first waterproof portion and the corresponding second waterproof portion. Each waterproof cover is fixedly connected to a corresponding first waterproof portion and a corresponding second waterproof portion by injection molding.

In the embodiments of the present disclosure, the outer side of each of the wire groups of the waterproof light string is covered with a corresponding insulating layer, which waterproof the wire groups. Meanwhile, a periphery of each of the lamp beads of the waterproof light string in the embodiments of the present disclosure is limited by the first waterproof portion of a corresponding first shell and the second waterproof portion of a corresponding second shell. The first waterproof portion of each first shell and the second waterproof portion of each second shell is covered by a corresponding waterproof cover, and each waterproof cover is fixedly connected to the corresponding first waterproof portion of a corresponding first shell and the corresponding second waterproof portion of a corresponding second shell, so that a fixed connection position between each first waterproof portion and the corresponding second waterproof portion is covered, and the fixed connection position between each first shell and the corresponding second shell is sealed, which realizes effective waterproof of each of the lamp beads limited by each first waterproof portion of each first shell and the corresponding second waterproof portion of the corresponding second shell. Therefore, on a basis that the wire groups are waterproof, in the embodiments of the present disclosure, the lamp beads are effectively waterproof, realizing effective waterproofing of the waterproof light string, and improving application scenarios of the waterproof light string. Thus, the waterproof light string is capable of being used outdoors for a long time.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

For a complete understanding of the present disclosure and its characteristics, the following description will be made in conjunction with the accompanying drawings, where same reference numbers in the following description indicate same structures.

FIG. 1 is a schematic diagram of a waterproof light string according to a first embodiment of the present disclosure.

FIG. 2 is a schematic diagram of lamp beads assembled with a wire assembly of the waterproof light string according to the first embodiment of the present disclosure.

FIG. 3 is an enlarged schematic diagram of portion X shown in FIG. 2.

FIG. 4 is an exploded schematic diagram of a waterproof assembly of the waterproof light string according to the first embodiment of the present disclosure.

FIG. 5 is a schematic diagram of a first shell of the waterproof assembly of the waterproof light string according to the first embodiment of the present disclosure.

FIG. 6 is another schematic diagram of the first shell of the waterproof assembly of the waterproof light string according to the first embodiment of the present disclosure.

FIG. 7 is a schematic diagram of a second shell of the waterproof assembly of the waterproof light string according to the first embodiment of the present disclosure.

FIG. 8 is another schematic diagram of the second shell of the waterproof assembly of the waterproof light string according to the first embodiment of the present disclosure.

FIG. 9 is a schematic diagram of a waterproof cover of the waterproof assembly of the waterproof light string according to the first embodiment of the present disclosure.

FIG. 10 is a schematic diagram of the waterproof light string according to a second embodiment of the present disclosure.

FIG. 11 is a schematic diagram of a first embodiment of a positioning piece of the waterproof light string according to the second embodiment of the present disclosure.

FIG. 12 is a schematic diagram of a second embodiment of the positioning piece of the waterproof light string according to the second embodiment of the present disclosure.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. The following description of at least one exemplary embodiment is merely illustrative and is in no way intended as any limitation on the present disclosure, applications thereof, and use thereof. Based on the embodiments of the present disclosure, all other embodiments obtained by those of ordinary skill in the art without creative work shall fall within the protection scope of the present disclosure.

Reference herein to “embodiment” or “implement” means that a particular feature, structure, or characteristic described in connection with one embodiment or one implement may be included in at least one embodiment of the present disclosure. The appearances of the “embodiment” in various positions in the specification are not necessarily referring to the same embodiment, and are not independent or alternative embodiments mutually exclusive of other embodiments. Those skilled in the art explicitly and implicitly understand that the embodiments described herein may be combined with other embodiments.

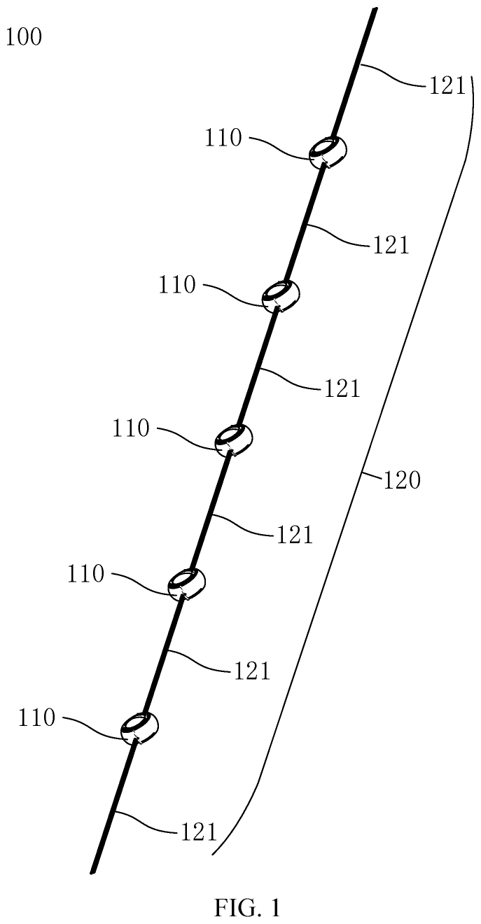

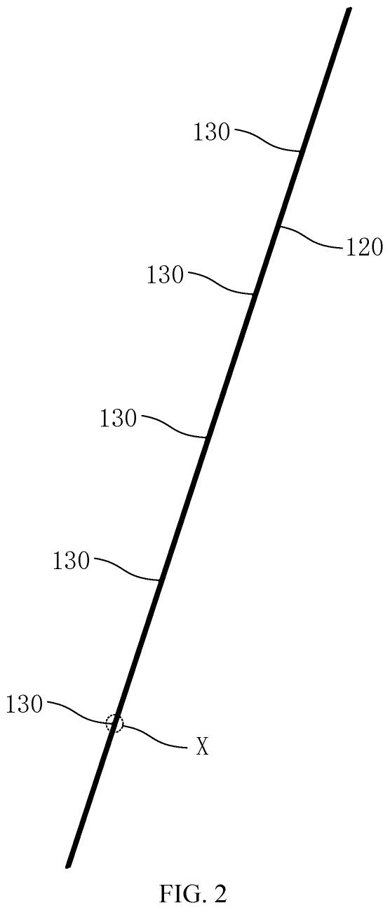

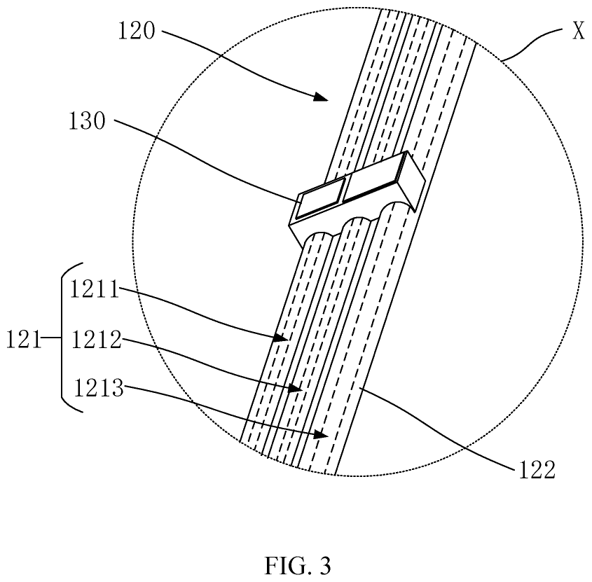

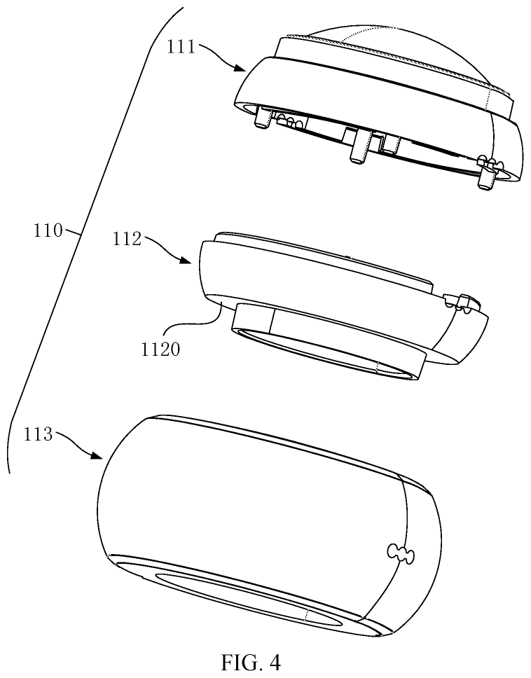

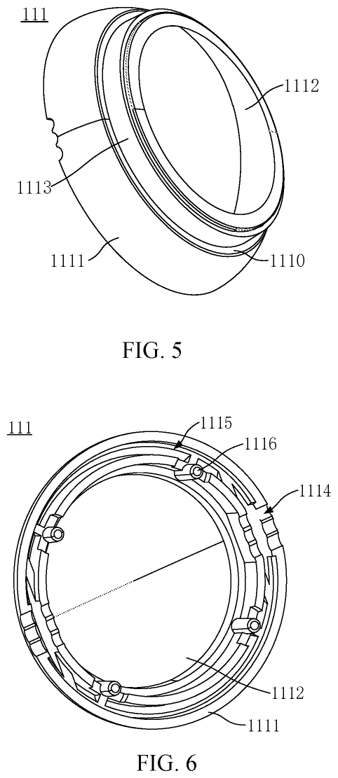

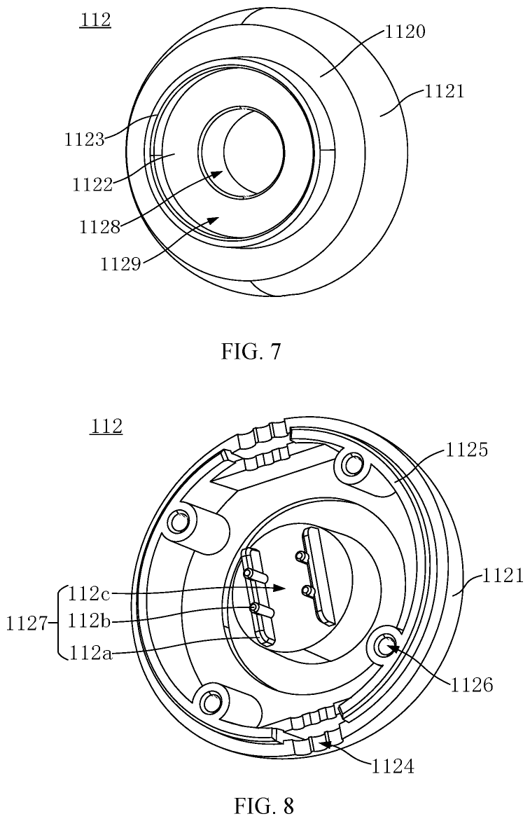

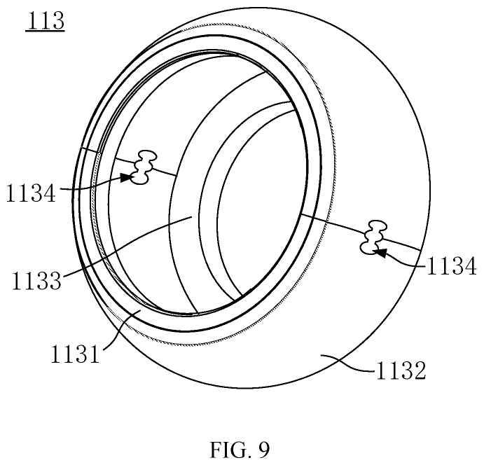

As shown in FIGS. 1-9, in one embodiment, the present disclosure provides a waterproof light string 100. The waterproof light string 100 includes a wire assembly 120, lamp beads 130, and waterproof assemblies 110.

The wire assembly 120 includes wire groups 121 and insulating layers 122. Each of the insulating layers 122 covers an outer side of a corresponding wire group 121 of the wire groups 121. Each of the wire groups 121 includes three wires. For instance, each of the wire groups 121 includes a first wire 1211, a second wire 1212, and a third wire 1213. It should be understood that in the embodiment of the present disclosure, the number of the wires included in each of the wire groups 121 is not limited to three, and four wires may be provided in other alternative embodiments.

The first wire 1211, the second wire 1212, and the third wire 1213 of each of the wire groups 121 are sequentially disposed at intervals. An outer side of the first wire 1211, outer side of the second wire 1212, and an outer side of the third wire 1213 of each of the wire groups 121 are covered by the corresponding insulating layer 122. The insulating layers 122 may be made from one of rubber, polyethylene (PE), polyvinyl chloride (PVC), etc. It should be understood that the insulating layers 122 are made from an insulating material that is flexible.

Each first wire 1211 is a positive wire, each second wire 1212 is a signal wire, and each third wire 1213 is a negative wire. Each first wire 1211, each second wire 1212, and each third wire 1213 are made of one of copper and aluminum. It should be understood that each first wire 1211, each second wire 1212, and each third wire 1213 may also be made of a variety of materials, such as one of copper-clad aluminum and copper-clad iron.

The number of the lamp beads is one less than the number of the wire groups 121. That is, the number of the wire groups 121 is one more than the number of the lamp beads 130. Each of the lamp beads 130 is electrically connected to corresponding two adjacent wire groups 121. For instance, each of the lamp beads 130 is welded to the corresponding two adjacent wire groups 121.

In one optional embodiment of the present disclosure, each of the lamp beads 130 includes at least one light-emitting chip directly welded to the corresponding two wire groups 121, realizing an electrical connection between each light-emitting chip and the corresponding two wire groups 121. In the prior art, lamp beads include substrates and light-emitting chips disposed on the substrates. Each of the substrates realizes an electrical connection between a corresponding light-emitting chip and corresponding two wire groups through welding a soldering plate disposed thereon (i.e., a bonding pad) to the corresponding two wire groups. Compared with the prior art, the present disclosure greatly reduces a volume of each of the lamp beads 130, thereby greatly reducing a space occupied by each of the lamp beads 130 on the waterproof light string 100.

Each light-emitting chip may be an LED light-emitting chip, and each light-emitting chip is selected from one of a red LED light-emitting chip, a green LED light-emitting chip, and a blue LED light-emitting chip.

Each of the waterproof assemblies 110 includes a first shell 111, a second shell 112, and a waterproof cover 113.

Each first shell 111 includes a first waterproof portion 1111 and a light-transmitting portion 1112 fixedly connected to the first waterproof portion 1111. Each light-transmitting portion 1112 is capable of transmitting light generated by a corresponding lamp bead 130 of the lamp beads 130, so that the light generated by the lamp beads emit outside of the waterproof light string 100. Each light-transmitting portion 1112 is transparent. In one optional embodiment of the present disclosure, each light-transmitting portion 1112 includes a convex transparent structure. In other words, each light-transmitting portion 112 is the convex transparent structure. Each light-transmitting portion 1112 is convexly disposed from a corresponding second shell 112 toward a corresponding first shell 111. It is understood that each light-transmitting portion 1112 is disposed outwardly from an inner surface of a corresponding first shell 111 toward an outer surface of the corresponding first shell 111, so as to realize light concentration of each light-transmitting portion 1112.

In one optional embodiment of the present disclosure, each first shell 111 further includes a first convex ring 1113 disposed around a periphery of a corresponding light-transmitting portion 1112. Each first convex ring 113 is connected to the corresponding light-transmitting portion 1112 and a corresponding first waterproof portion 1111. Optionally, the first waterproof portion 1111, the first convex ring 1113, and the light-transmitting portion 1112 of each first shell 111 are integrally formed by using a first mold. In one optional embodiment of the present disclosure, the first waterproof portion 1111, the first convex ring 1113, and the light-transmitting portion 1112 of each first shell 111 are transparent.

Each second shell 112 includes a second waterproof portion 1121 and a positioning portion 1122 fixedly connected to the second waterproof portion. Each first waterproof portion 1111 is fixedly connected to a corresponding second waterproof portion 1121 to limit a corresponding lamp bead 130 between each first waterproof portion 1111 and the corresponding second waterproof portion 1121. Each first waterproof portion 1111 and the corresponding second waterproof portion 1121 limits the corresponding lamp bead 130, that is, each of the lamp beads 130 is disposed in a cavity formed by each first waterproof portion 1111 and the corresponding second waterproof portion 1121. It is understood as each of the lamp beads 130 is fixedly disposed in the cavity formed by each first waterproof portion 1111 and the corresponding second waterproof portion 1121.

In one optional embodiment of the present disclosure, each second shell 112 further includes a second convex ring 1123 disposed around a corresponding positioning portion 1122. The second convex ring 1123, the positioning portion 1122, and the second waterproof portion 1121 of each second shell 112 are integrally formed by using a second mold. In one optional embodiment of the present disclosure, the second convex ring 1123, the positioning portion 1122, and the second waterproof portion 1121 of each second shell 112 are light-proof. That is, the second convex ring 1123, the positioning portion 1122, and the second waterproof portion 1121 of each second shell 112 are opaque.

Each positioning portion 1122 includes a first positioning groove 1128 and a second positioning groove 1129 communicated with the first positioning groove 1128. Each second positioning groove 1129 is located on an outer side of a corresponding first positioning groove 1128. Each second positioning groove 1129 is formed by a corresponding second convex ring 1123 surrounding a corresponding positioning portion 1122. In one embodiment of the present disclosure, each first positioning groove 1128 and each second positioning groove 1129 are assembled with other device such as a corresponding positioning piece to achieve a positioning function. The present disclosure takes an example that he waterproof light string 100 includes positioning pieces for illustration.

In one optional embodiment of the present disclosure, each first waterproof portion 1111 and the corresponding second waterproof portion 1121 are connected together first and then covered by the corresponding waterproof cover 113. For instance, a waterproof groove 1115 is defines on one end of each first waterproof portion 1111 away from a corresponding light-transmitting portion 1112. A waterproof convex rib 1125 is disposed on one end of each second waterproof portion 1121 away from a corresponding positioning portion 1122. Each waterproof convex rib 1125 is placed in a corresponding waterproof groove 1115. A groove wall of each waterproof groove 1115 and the corresponding waterproof convex rib 1125 limit each other, which not only facilitates a connection between each first waterproof portion 1111 and the corresponding second waterproof portion 1121, but also facilitates each waterproof cover to cover a connection position between each first waterproof portion 1111 and the corresponding second waterproof portion 1121.

Optionally, each first waterproof portion 1111 includes first connecting structures 1116. Each second waterproof portion 1121 includes second connecting structures 1126. The second connecting structure 1126 of each second waterproof portion 1121 are fixedly connected to the first connecting structures 1116 of each first waterproof portion 1111.

Each of the first connecting structures 1116 is a cylinder structure, each of the second connecting structures 1126 is a groove, and each of the first connecting structures 1116 is plugged into a corresponding second connecting structure 1126. It should be noted that a fixing connection method of each of the first connecting structures 1116 and the corresponding second connecting structure is not limited thereto.

In the embodiment of the present disclosure, when each first waterproof portion 111 is connected to the corresponding second waterproof portion, each of the first connecting structures 1116 is connected to the corresponding second connecting structure 1126, and each waterproof convex rob 1125 is engaged with the corresponding waterproof groove, so connection stability between each first waterproof portion 111 and the corresponding second waterproof portion is enhanced. Further, it is more conducive for each waterproof cover to cover the fixed connection position between each first waterproof portion 1111 and the corresponding second waterproof portion 1121. It should be understood that other connection methods may be used between each first waterproof portion 1111 and the corresponding second waterproof portion 1121, which are not limited thereto and are not described for details herein.

Each of the lamp beads 130 is limited between each first waterproof portion 1111 and the corresponding second waterproof portion 1121, and is fixed by the corresponding second shell 112. Specifically, each second waterproof portion 1121 includes a limiting structure 1127. Each limiting structure 1127 is configured to limit a corresponding lamp bead 130 to each second waterproof portion 1121. Each limiting structure 1127 is opposite to a corresponding positioning portion 1122.

Specifically, each limiting structure 1127 is disposed opposite to the corresponding first positioning groove 1128. In one optional embodiment of the present disclosure, each limiting structure 1127 includes two limiting plates 112a disposed opposite to each other to define a limit groove 112c. Each of the lamp beads 130 are placed in a corresponding limit groove 112c and limited by the two limiting plates 112a of each limiting structure 1127. In order to increase a limiting effect on each of the lamp beads 130, in other embodiments of the present disclosure, each limiting structure 1127 further includes limiting columns 112b. Two of the limiting columns 112b of each limiting structure 1127 are fixedly connected to one of the two limiting plate 112a of each limiting structure 1127. The limiting columns 112b of each limiting structure 1127 are located in the limit grooves 112c of each limiting structure 1127, so that the limiting columns 112b of each limiting structure 1127 effectively limit the corresponding lamp bead 130. It should be noted that each limiting structure 1127 in the embodiments of the present disclosure facilitates mounting and dismounting of the corresponding lamp beads 130. It is understood that a structure of each limiting structure 1127 configured to limit the corresponding lamp bead 130 is not limited thereto.

In the embodiment of the present disclosure, each second waterproof portion 1121 includes the limit structure 1127 for limiting the corresponding lamp bead 130. In order to increase the limitation and protection to each of the lamp beads 130, in one optional embodiment of the present disclosure, each first waterproof portion 1111 and each second waterproof portion 1121 further include structures for limiting the corresponding two adjacent wire groups 121. For instance, two first limiting grooves 1114 are defined on one end of each first waterproof portion 1111 away from a corresponding light-transmitting portion 1112. Two second limiting grooves 1124 are defined on one end of each second waterproof portion 1121 away from a corresponding positioning portion 1122. Each of the wire groups 121 is placed in a corresponding second limiting groove 1124 of a corresponding second waterproof portion 1121 and a corresponding first limiting groove 1114 of a corresponding first waterproof portion 1121. Specifically, each of the first limiting grooves 1114 and a corresponding second limiting groove 1124 are configured to limit a corresponding wire group 121. Namely, each of the wire groups 121 is placed in the corresponding first limiting groove 1114 and the corresponding second limiting groove 1124 opposite to the corresponding first limiting groove 1114, and is limited by the groove wall of a corresponding first limiting groove 1114 and the groove wall of a corresponding second limiting groove 1124. It is understood that each of the first limiting grooves 1114 and each of the second limiting grooves 1124 include sub-grooves. The number of the sub-grooves of each of the first limiting grooves 1114 and the number of the sub-grooves of each of the second limiting grooves 1124 are same as the number of the wires included in each of the wire groups 121.

Each waterproof cover 113 covers a corresponding first waterproof portion 1111 and a corresponding second waterproof portion 1121, and each waterproof cover 113 is fixedly connected to the corresponding first waterproof portion 1111 and the corresponding second waterproof portion 1121, so as to prevent liquid from entering each of the lamp beads 130 from a gap between each first waterproof portion 1111 and the corresponding second waterproof portion 1121.

Optionally, each waterproof cover 113 includes a first cover body 1131, a second cover body 1132, and a third cover body 1133.

Each first cover body 1131 covers a corresponding first convex ring 1113 and is fixedly connected to the corresponding first convex ring 1113. Each second cover body 1132 and a corresponding first cover body 1131 are integrally formed. Each second cover body 1132 covers a corresponding first waterproof portion 1111 and a corresponding second waterproof portion 1121 and is fixedly connected to the corresponding first waterproof portion 1111 and the corresponding second waterproof portion 1121 Each third cover body 1133 and a corresponding second cover body 1132 are integrally formed. Each third cover body 1133 covers a corresponding second convex ring 1123 and is fixedly connected to the corresponding second convex ring 1123. In one optional embodiment of the present disclosure, each first cover body 1131, the corresponding second cover body 1132, and the corresponding third cover body 1133 are integrally formed, such as integrally formed by using a third mold.

For instance, in the embodiments of the present disclosure, after the at least one light-emitting chip of each of the lamp beads 130 is welded to the corresponding two adjacent wire groups 121, each of the lamp beads 130 is fixedly connected to the corresponding two adjacent wire groups 121 each covered with the insulating layer 122. Parts of the corresponding two adjacent wire groups 121 are placed in the second waterproof portion 1121 of each second shell 112, and each of the lamp beads 130 is installed in a corresponding limiting structure 1127. Then, each first shell 111 and the corresponding second shell 112 are fixed, and each of the first limiting grooves 1114 and the corresponding second limiting groove 1124 are aligned with the corresponding wire group 121 to ensure that each of the wire groups 121 is located in the corresponding first limiting groove 1114 and the corresponding second limiting groove 1124. Then, each first shell 111 and the corresponding second shell 112 that are fixedly connected together are placed in a corresponding third mold, and the corresponding waterproof cover 113 is formed on an outer surface of the first waterproof portion 1111 thereof, an outer surface of the first convex ring 1113 thereof, an outer surface of the second waterproof portion 1121 thereof, and an outer surface of the second convex ring 1123 thereof. Therefore, each waterproof cover 113 not only covers the corresponding first waterproof portion 1111, the corresponding first convex ring 1113, the corresponding second waterproof portion 1121, and the corresponding second convex ring 1123, but also is fixedly connected to the corresponding first waterproof portion 1111, the corresponding first convex ring 1113, the corresponding second waterproof portion 1121, and the corresponding second convex ring 1123 to realize a stable fixed connection relationship and an effective waterproof performance of the waterproof light string.

In one optional embodiment of the present disclosure, each first waterproof portion 1111 and each second waterproof portion 1121 are boss structures. A shape of each second cover body 1132 is matched with each first waterproof portion 1111 and each second waterproof portion 1121. A maximum diameter of each first cover body 1131 is not greater than a minimum diameter of each second cover body 1132. A maximum diameter of each third cover body 1133 is not greater a minimum diameter of each second cover body 1132. A minimum diameter of each third cover body is less than a minimum diameter of each first cover body. Therefore, it is ensured that each light-transmitting portion 1112 is sufficiently exposed from a corresponding first cover body 1131 to effectively transmit light. Each waterproof cover 113 is light-proof. For instance, each first cover body 1131, each second cover body 1132, and each third cover body 1133 are light-proof, and each first cover body 1131, each second cover body 1132, and each third cover body 1133 are opaque.

In the embodiments of the present disclosure, the outer side of each of the wire groups 121 of the waterproof light string 100 is covered with the corresponding insulating layer 122, which waterproof the wire groups 121. Meanwhile, a periphery of each of the lamp beads 130 of the waterproof light string 100 in the embodiments of the present disclosure is limited by the first waterproof portion 1111 of a corresponding first shell 111 and the second waterproof portion 1121 of a corresponding second shell 112. The first waterproof portion 1111 of each first shell 111 and the second waterproof portion 1121 of each second shell 112 is covered by the corresponding waterproof cover 113, and each waterproof cover 113 is fixedly connected to the corresponding first waterproof portion 1111 of the corresponding first shell 111 and the corresponding second waterproof portion 1121 of the corresponding second shell 112, so that the fixed connection position between each first waterproof portion 1111 and the corresponding second waterproof portion 1121 is covered, and the fixed connection position between each first shell 111 and the corresponding second shell 112 is sealed, which realizes effective waterproof of each of the lamp beads limited by each first waterproof portion 1111 of each first shell 111 and the corresponding second waterproof portion 1121 of the corresponding second shell 112. Therefore, on a basis that the wire groups 121 are waterproof, in the embodiments of the present disclosure, the lamp beads are effectively waterproof, realizing effective waterproofing of the waterproof light string 100, and improving application scenarios of the waterproof light string 100. Thus, the waterproof light string 100 is capable of being used outdoors for a long time.

Each waterproof cover 113 is fixedly connected to the first waterproof portion 1111 of the corresponding first shell 111 and the second waterproof portion 1121 of the corresponding second shell 112 by injection molding, so that the fixed connection position between the first waterproof portion 1111 of each first shell 111 and the second waterproof portion 1121 of the corresponding second shell 112 are strictly sealed. For instance, each waterproof cover 113 is fixedly connected to the corresponding first waterproof portion 1111 and the corresponding second waterproof portion 1121 by injection molding.

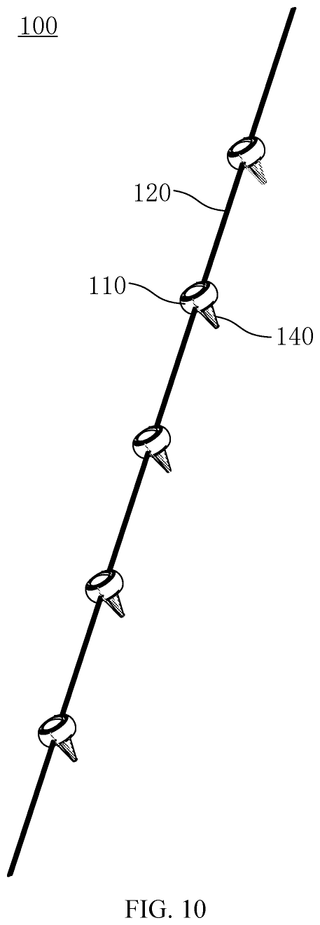

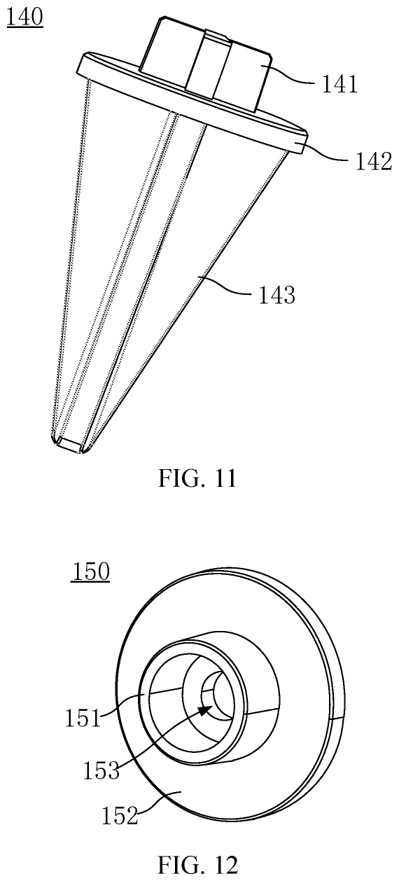

As shown in FIG. 10 and FIG. 11, FIG. 10 is a schematic diagram of the waterproof light string according to a second embodiment of the present disclosure, and FIG. 11 is a schematic diagram of a first embodiment of one of positioning pieces of the waterproof light string according to the second embodiment of the present disclosure. The waterproof light string 100 further includes the positioning pieces 140. Each of the positioning pieces is connected to a corresponding positioning portion 1122. Each of the positioning pieces 140 includes a first positioning structure 141 and a second positioning structure 142. Each first positioning structure 141 is placed in a corresponding first positioning groove 1128. Each second positioning structure 142 is placed in a corresponding second positioning groove 1129. Each first positioning structure 141 and a corresponding second positioning structure 142 are integrally disposed. Each of the positioning pieces 140 further includes a third positioning structure 143 integrally disposed with a corresponding second positioning structure 142. Each third positioning structure 143 protrudes out of a corresponding positioning portion 1122. Optionally, a size of each third positioning structure 143 gradually increases from a free end thereof to a position of the corresponding second positioning structure 142. Each third positioning structure 143 is allowed to be fixed on an external structure such as a wall, so the waterproof light string 100 is allowed to be fixed in a predetermined location such as outdoors.

It should be noted that structures of the positioning pieces 140 are not limited thereto. As shown in FIG. 12, FIG. 12 is a schematic diagram of a second embodiment of one of the positioning pieces of the waterproof light string according to the second embodiment of the present disclosure. Each of the positioning pieces 150 includes a first positioning structure 151 and a second positioning structure 152. Each first positioning structure 151 is placed in a corresponding first positioning groove 1128. Each second positioning structure 152 is placed in a corresponding second positioning groove 1129. Each first positioning structure 151 and a corresponding second positioning structure 152 are integrally formed. Each of the positioning pieces 150 includes a positioning hole 153. Each positioning hole 153 penetrates a corresponding first positioning structure 151 and a corresponding second positioning structure 152. Each positioning hole 153 is allowed to be connected to an external device such as a fixing strap, so that the waterproof light string 100 is allowed to be fixed in the predetermined location such as outdoors.

The above embodiments of the present disclosure provide a detailed illustration to the waterproof light string. In the present disclosure, specific embodiments are applied to illustrate the principles and implementations of the present disclosure. The above description of the embodiments is only used to better understand methods and core ideas of the present disclosure. Meanwhile, according to the ideas of the present disclosure, changes are made in the specific implementations and the application scope by those skilled in the art. Therefore, the contents of the specification should not be regarded as a limitation of the present disclosure.

1. A waterproof light string, comprising:
a wire assembly,
lamp beads, and
waterproof assemblies;
wherein the wire assembly comprises wire groups and insulating layers; each of the insulating layers covers an outer side of a corresponding wire group of the wire groups, wherein each of the lamp beads comprises at least one light-emitting chip without substrate directly welded to the corresponding two wire groups;
each of the lamp beads is electrically connected to corresponding two adjacent wire groups; each of the waterproof assemblies comprises a first shell, a second shell, and a waterproof cover;
each first shell comprises a first waterproof portion and a light-transmitting portion fixedly connected to the first waterproof portion; each light-transmitting portion is capable of transmitting light generated by a corresponding lamp bead of the lamp beads; each second shell comprises a second waterproof portion and a positioning portion fixedly connected to the second waterproof portion; each first waterproof portion is fixedly connected to a corresponding second waterproof portion to secure a corresponding lamp bead between each first waterproof portion and the corresponding second waterproof portion;
each waterproof cover covers a corresponding first waterproof portion and a corresponding second waterproof portion without covering the light-transmitting portion and the positioning portion, each waterproof cover is light-proof, and each waterproof cover is fixedly connected to the corresponding first waterproof portion and the corresponding second waterproof portion, and wherein the light-transmitting portion and the positioning portion are disposed at two opposite sides of the corresponding waterproof cover, so as to prevent liquid from entering each of the lamp beads from a gap between each first waterproof portion and the corresponding second waterproof portion, wherein corresponding first waterproof portion and a corresponding second waterproof portion.

2. The waterproof light string according to claim 1, wherein each first shell further comprises a first convex ring disposed around a periphery of a corresponding light-transmitting portion; each first convex ring is connected to the corresponding light-transmitting portion and a corresponding first waterproof portion; each second shell further comprises a second convex ring disposed around a corresponding positioning portion.

3. The waterproof light string according to claim 2, wherein each waterproof cover covers a corresponding first convex ring and a corresponding second convex ring.

4. The waterproof light string according to claim 3, wherein each waterproof cover comprises a first cover body, a second cover body, and a third cover body; each first cover body covers a corresponding first convex ring and is fixedly connected to the corresponding first convex ring by covering the second step; each second cover body and a corresponding first cover body are integrally formed; each second cover body covers a corresponding first waterproof portion and a corresponding second waterproof portion and is fixedly connected to the corresponding first waterproof portion and the corresponding second waterproof portion; each third cover body and a corresponding second cover body are integrally formed; each third cover body covers a corresponding second convex ring and is fixedly connected to the corresponding second convex ring by covering the first step.

5. The waterproof light string according to claim 4, wherein each first waterproof portion and each second waterproof portion are boss structures; a shape of each second cover body is matched with each first waterproof portion and each second waterproof portion.

6. The waterproof light string according to claim 4, wherein a maximum diameter of each first cover body is not greater than a minimum diameter of each second cover body.

7. The waterproof light string according to claim 4, wherein a maximum diameter of each third cover body is not greater a minimum diameter of each second cover body; a minimum diameter of each third cover body is less than a minimum diameter of each first cover body.

8. The waterproof light string according to claim 1, wherein the waterproof light string further comprises positioning pieces; each of the positioning pieces is connected to a corresponding positioning portion.

9. The waterproof light string according to claim 8, wherein each positioning portion comprises a first positioning groove and a second positioning groove communicated with the first positioning groove; each of the positioning pieces comprises a first positioning structure and a second positioning structure; each first positioning structure is placed in a corresponding first positioning groove; each second positioning structure is placed in a corresponding second positioning groove; each first positioning structure and a corresponding second positioning structure are integrally formed.

10. The waterproof light string according to claim 9, wherein each of the positioning pieces comprises a positioning hole; each positioning hole penetrates a corresponding first positioning structure and a corresponding second positioning structure.

11. The waterproof light string according to claim 9, wherein each of the positioning pieces further comprises a third positioning structure integrally disposed with a corresponding second positioning structure; each third positioning structure protrudes out of a corresponding positioning portion; a size of each third positioning structure gradually increases from a free end thereof to a position of the corresponding second positioning structure.

12. (canceled)

13. The waterproof light string according to claim 1, wherein each light-transmitting portion is transparent; and/or
each second shell is opaque.

14. The waterproof light string according to claim 1, wherein each first waterproof portion comprises first connecting structures; each second waterproof portion comprises second connecting structures; the second connecting structures of each second waterproof portion are respectively fixedly connected to the first connecting structures of each first waterproof portion.

15. The waterproof light string according to claim 14, wherein a waterproof groove is defined on one end of each first waterproof portion away from a corresponding light-transmitting portion; a waterproof convex rib is disposed on one end of each second waterproof portion away from a corresponding positioning portion; each waterproof convex rib is placed in a corresponding waterproof groove.

16. The waterproof light string according to claim 14, wherein two first limiting grooves are defined on one end of each first waterproof portion away from a corresponding light-transmitting portion; two second limiting grooves are defined on one end of each second waterproof portion away from a corresponding positioning portion; each of the wire groups is placed in a corresponding second limiting groove of a corresponding second waterproof portion and a corresponding first limiting groove of a corresponding first waterproof portion; each second waterproof portion comprises a limiting structure; each limiting structure is configured to limit a corresponding lamp bead to each second waterproof portion; each limiting structure is opposite to a corresponding positioning portion.

17. (canceled)

18. The waterproof light string according to claim 1, wherein each waterproof cover, the corresponding first waterproof portion and the corresponding second waterproof portion are fixedly connected by injection molding.

19. (canceled)

20. The waterproof light string according to claim 4, wherein the first cover body extends along a horizontal direction, the second cover body extends along a longitudinal direction, and the third cover body extends along a horizontal direction.
